(19) United States
(12) Patent Application Publication
(10) Pub. No.: US 2024/0192917 A1
(43) Pub. Date: Jun. 13, 2024

(54) DETECTING NOTABLE OCCURRENCES ASSOCIATED WITH EVENTS

(71) Applicant: Apple Inc., Cupertino, CA (US)

(72) Inventors: Gavin K. DUFFY, Los Gatos, CA (US); Raymond M. MACHARIA, San Francisco, CA (US); Jessica J. PECK, Morgan Hill, CA (US); Robert M. SCHULMAN, Los Gatos, CA (US)

(21) Appl. No.: 18/585,886

(22) Filed: Feb. 23, 2024

Related U.S. Application Data
(63) Continuation of application No. PCT/US2022/041927, filed on Aug. 29, 2022.
(60) Provisional application No. 63/239,542, filed on Sep. 1, 2021.

(51) Int. Cl. G06F 3/16; G06F 3/01; G10L 15/22; H04N 21/2187; H04N 21/431

(52) U.S. Cl. CPC G06F 3/167; G06F 3/013; G10L 15/22; H04N 21/2187; H04N 21/4316; G10L 2015/223

(57) ABSTRACT

An example process includes concurrently displaying: a primary region displaying a first user interface; and a virtual affordance having a first display state and display content, where the display content represents an event and includes updates of the event; while concurrently displaying the primary region and the virtual affordance: detecting a predetermined type of occurrence associated with the event; in response to detecting the predetermined type of occurrence, modifying the first display state to a second display state; after modifying the first display state to the second display state, receiving a speech input; and determining, using context information determined based on the second display state, whether the speech input corresponds to the virtual affordance; and in accordance with a determination that the speech input corresponds to the virtual affordance, replacing, in the primary region, the display of the first user interface with a display of the event.

### CROSS-REFERENCE TO RELATED APPLICATIONS

This application is a continuation of PCT Application No. PCT/US2022/041927, entitled “DETECTING NOTABLE OCCURRENCES ASSOCIATED WITH EVENTS,” filed on Aug. 29, 2022, which claims priority to U.S. Patent Application No. 63/239,542, entitled “DETECTING NOTABLE OCCURRENCES ASSOCIATED WITH EVENTS,” filed on Sep. 1, 2021. The entire contents of each of these applications are hereby incorporated by reference in their entireties.

### FIELD

This relates to notifying users about notable occurrences in events of user interest and to displaying an event of user interest when a notable occurrence happens in the event.

### BACKGROUND

Digital assistants allow users to interact with electronic devices via natural language input. For example, after a user provides a spoken request to a digital assistant implemented on an electronic device, the digital assistant can determine a user intent corresponding to the spoken request. The digital assistant can then cause the electronic device to perform one or more task(s) to satisfy the user intent and to provide output(s) indicative of the performed task(s).

### SUMMARY

Example methods are disclosed herein. An example method includes at an electronic device having one or more processors, memory, and a display: concurrently displaying, on the display: a primary region displaying a first user interface; and a virtual affordance having a first display state and display content, where the display content represents an event and includes updates of the event; while concurrently displaying the primary region and the virtual affordance: detecting a predetermined type of occurrence associated with the event; in response to detecting the predetermined type of occurrence, modifying the first display state of the virtual affordance to a second display state different from the first display state; after modifying the first display state to the second display state, receiving a speech input; and determining, using context information determined based on the second display state of the virtual affordance, whether the speech input corresponds to the virtual affordance; and in accordance with a determination that the speech input corresponds to the virtual affordance, replacing, in the primary region, the display of the first user interface with a display of the event.

Example non-transitory computer-readable media are disclosed herein. An example non-transitory computer-readable storage medium stores one or more programs. The one or more programs comprise instructions, which when executed by one or more processors of an electronic device having a display, cause the electronic device to: concurrently display, on the display: a primary region displaying a first user interface; and a virtual affordance having a first display state and display content, where the display content represents an event and includes updates of the event; while concurrently displaying the primary region and the virtual affordance: detect a predetermined type of occurrence associated with the event; in response to detecting the predetermined type of occurrence, modify the first display state of the virtual affordance to a second display state different from the first display state; after modifying the first display state to the second display state, receive a speech input; and determine, using context information determined based on the second display state of the virtual affordance, whether the speech input corresponds to the virtual affordance; and in accordance with a determination that the speech input corresponds to the virtual affordance, replace, in the primary region, the display of the first user interface with a display of the event.

Example electronic devices are disclosed herein. An example electronic device comprises a display; one or more processors; a memory; and one or more programs, where the one or more programs are stored in the memory and configured to be executed by the one or more processors, the one or more programs including instructions for: concurrently displaying, on the display: a primary region displaying a first user interface; and a virtual affordance having a first display state and display content, where the display content represents an event and includes updates of the event; while concurrently displaying the primary region and the virtual affordance: detecting a predetermined type of occurrence associated with the event; in response to detecting the predetermined type of occurrence, modifying the first display state of the virtual affordance to a second display state different from the first display state; after modifying the first display state to the second display state, receiving a speech input; and determining, using context information determined based on the second display state of the virtual affordance, whether the speech input corresponds to the virtual affordance; and in accordance with a determination that the speech input corresponds to the virtual affordance, replacing, in the primary region, the display of the first user interface with a display of the event.

Modifying the first display state of the virtual affordance to the second display state in response to detecting the predetermined type of occurrence provides the user with feedback that a notable moment (e.g., highlight) has occurred in an event of interest and that the user can provide input to display the event. Thus, a user can simultaneously view multiple events of interest (e.g., sports games) and is informed about when they may desire to view an event of interest (e.g., a sports game in which a highlight occurred) in a primary region of a display. Providing improved feedback to the user improves device operability and makes the user-device interaction more efficient (e.g., by helping the user to provide correct inputs and reducing user mistakes) which additionally, reduces power usage and improves device battery life by enabling quicker and more efficient device usage.

Replacing the display of the first user interface with a display of the event when predetermined conditions are met allows the device to accurately determine an event of interest and efficiently display the event in the primary region. Thus, a user may quickly and accurately cause display of the event in the primary display region, e.g., via speech inputs such as “turn that on.” Replacing the display of the first user interface with the display of the event when predetermined conditions are met without requiring further user input (e.g., after receiving the speech input) improves device operability and makes the user-device interaction more efficient (e.g., by reducing user inputs otherwise required to display the event, by reducing user inputs to cease display of incorrect events) which additionally, reduces power usage and improves device battery life by enabling quicker and more efficient device usage.

### BRIEF DESCRIPTION OF FIGURES

FIGS. 1A-1B depict exemplary systems for use in various extended reality technologies.

FIG. 2 illustrates a block diagram of a digital assistant, according to various examples.

FIGS. 3A-3J illustrate various content displayed on a display of a device, according to various examples.

FIG. 4 illustrates a process for displaying an event, according to various examples.

### DESCRIPTION

Examples of systems and techniques for implementing extended reality (XR) based technologies are described herein.

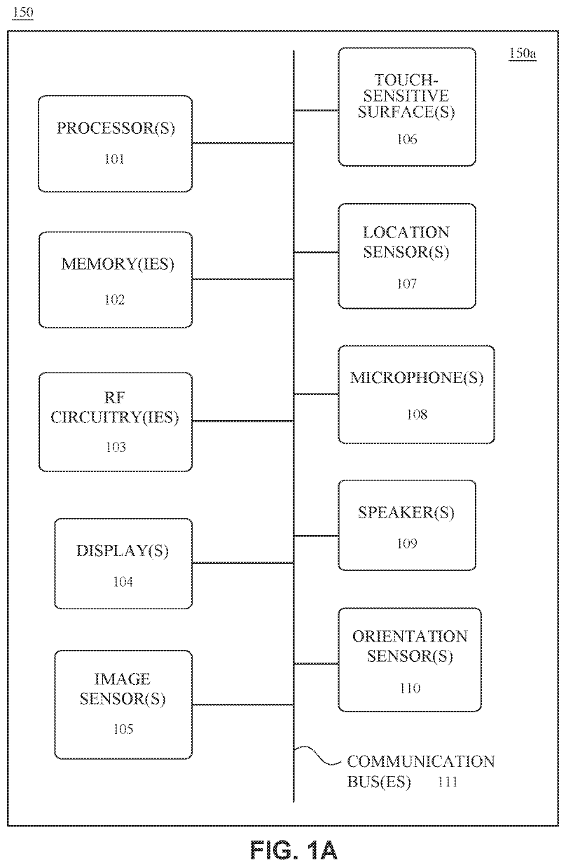

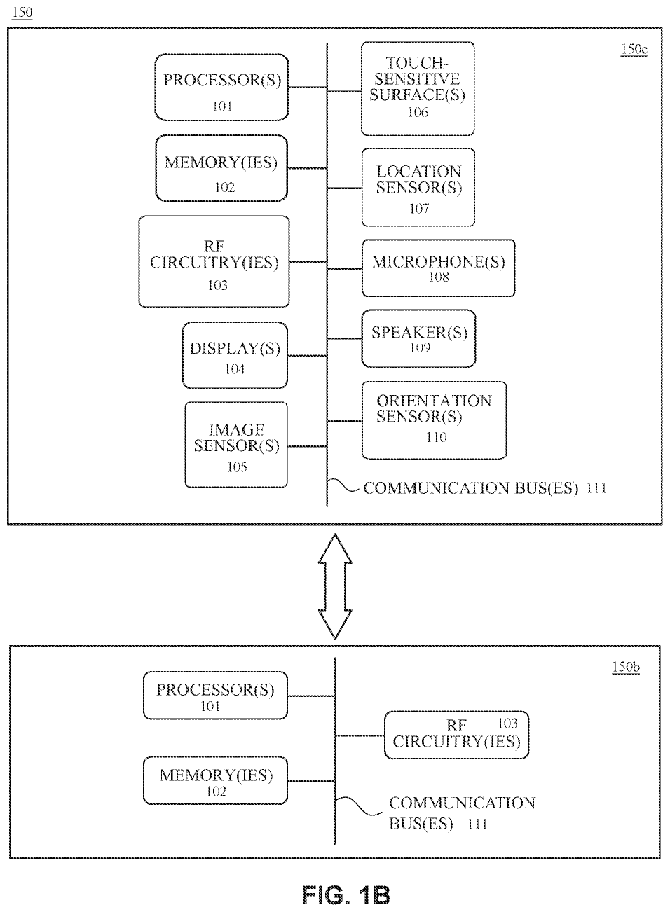

FIG. 1A and FIG. 1B depict exemplary system 150 used to implement various extended reality technologies.

In the example of FIG. 1A, system 150 includes device 150a. Device 150a includes at least some of: processor(s) 101, memory(ies) 102, RF circuitry(ies) 103, display(s) 104, image sensor(s) 105, touch-sensitive surface(s) 106, location sensor(s) 107, microphone(s) 108, speaker(s) 109, and orientation sensor(s) 110. Communication bus(es) 111 of device 150a optionally enable communication between the various components of device 150a.

In some examples, some components of system 150 are implemented in a base station device (e.g., a computing device such as a laptop, remote server, or mobile device) and other components of system 150 are implemented in a second device (e.g., a head-mounted device). In some examples, the base station device or the second device implements device 150a.

In the example of FIG. 1B, system 150 includes at least two devices in communication, e.g., via a wired connection or a wireless connection. First device 150c (e.g., a head-mounted device) includes at least some of: processor(s) 101, memory(ies) 102, RF circuitry(ies) 103, display(s) 104, image sensor(s) 105, touch-sensitive surface(s) 106, location sensor(s) 107, microphone(s) 108, speaker(s) 109, and orientation sensor(s) 110. Communication bus(es) 111 of first device 150c optionally enable communication between the components of first device 150c. Second device 150b, such as a base station device, includes processor(s) 101, memory(ies) 102, and RF circuitry(ies) 103. Communication bus(es) 111 of second device 150b optionally enable communication between the components of second device 150b.

Processor(s) 101 include, for instance, graphics processor(s), general processor(s), and/or digital signal processor(s).

Memory(ies) 102 are one or more non-transitory computer-readable storage mediums (e.g., flash memory, random access memory) storing computer-readable instructions. The computer-readable instructions, when executed by processor(s) 101, cause system 150 to perform various techniques discussed below.

RF circuitry(ies) 103 include, for instance, circuitry to enable communication with other electronic devices and/or with networks (e.g., intranets, the Internet, wireless networks (e.g., local area networks and cellular networks)). In some examples, RF circuitry(ies) 103 include circuitry enabling short-range and/or near-field communication.

In some examples, display(s) 104 implement a transparent or semi-transparent display. Accordingly, a user can view a physical setting directly through the display and system 150 can superimpose virtual content over the physical setting to augment the user's field of view. In some examples, display(s) 104 implement an opaque display. In some examples, display(s) 104 transition between a transparent or semi-transparent state and an opaque state.

In some examples, display(s) 104 implement technologies such as liquid crystal on silicon, a digital light projector, LEDs, OLEDs, and/or a laser scanning light source. In some examples, display(s) 104 include substrates (e.g., light waveguides, optical reflectors and combiners, holographic substrates, or combinations thereof) through which light is transmitted. Alternative example implementations of display(s) 104 include display-capable automotive windshields, display-capable windows, display-capable lenses, heads up displays, smartphones, desktop computers, or laptop computers. As another example implementation, system 150 is configured to interface with an external display (e.g., smartphone display). In some examples, system 150 is a projection-based system. For example, system 150 projects images onto the eyes (e.g., retina) of a user or projects virtual elements onto a physical setting, e.g., by projecting a holograph onto a physical setting or by projecting imagery onto a physical surface.

In some examples, image sensor(s) 105 include depth sensor(s) for determining the distance between physical elements and system 150. In some examples, image sensor(s) 105 include visible light image sensor(s) (e.g., charged coupled device (CCD) sensors and/or complementary metal-oxide-semiconductor (CMOS) sensors) for obtaining imagery of physical elements from a physical setting. In some examples, image sensor(s) 105 include event camera(s) for capturing movement of physical elements in the physical setting. In some examples, system 150 uses depth sensor(s), visible light image sensor(s), and event camera(s) in conjunction to detect the physical setting around system 150. In some examples, image sensor(s) 105 also include infrared (IR) sensor(s) (e.g., passive or active IR sensors) to detect infrared light from the physical setting. An active IR sensor implements an IR emitter (e.g., an IR dot emitter) configured to emit infrared light into the physical setting.

In some examples, image sensor(s) 105 are used to receive user inputs, e.g., hand gesture inputs. In some examples, image sensor(s) 105 are used to determine the position and orientation of system 150 and/or display(s) 104 in the physical setting. For instance, image sensor(s) 105 are used to track the position and orientation of system 150 relative to stationary element(s) of the physical setting. In some examples, image sensor(s) 105 include two different image sensor(s). A first image sensor is configured to capture imagery of the physical setting from a first perspective and a second image sensor is configured to capture imagery of the physical setting from a second perspective different from the first perspective.

Touch-sensitive surface(s) 106 are configured to receive user inputs, e.g., tap and/or swipe inputs. In some examples, display(s) 104 and touch-sensitive surface(s) 106 are combined to form touch-sensitive display(s).

In some examples, microphone(s) 108 are used to detect sound emanating from the user and/or from the physical setting. In some examples, microphone(s) 108 include a microphone array (e.g., a plurality of microphones) operating in conjunction, e.g., for localizing the source of sound in the physical setting or for identifying ambient noise.

Orientation sensor(s) 110 are configured to detect orientation and/or movement of system 150 and/or display(s) 104. For example, system 150 uses orientation sensor(s) 110 to track the change in the position and/or orientation of system 150 and/or display(s) 104, e.g., relative to physical elements in the physical setting. In some examples, orientation sensor(s) 110 include gyroscope(s) and/or accelerometer(s).

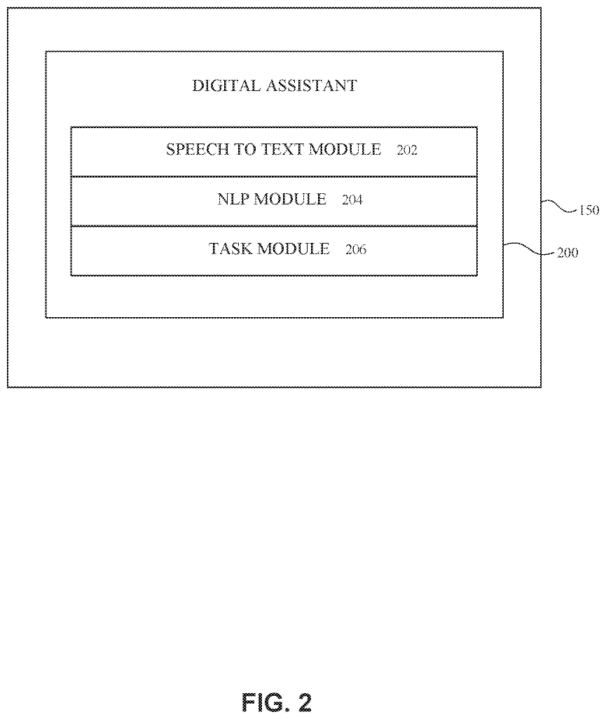

FIG. 2 illustrates a block diagram of digital assistant (DA) 200, according to various examples.

The example of FIG. 2 shows that DA 200 is implemented, at least partially, within system 150, e.g., within device 150a, 150b, or 150c. For example, DA 200 is at least partially implemented as computer-executable instructions stored in memory(ies) 102. In some examples, DA 200 is implemented in a distributed manner, e.g., distributed across multiple computing systems. For example, the components and functions of DA 200 are divided into a client portion and a server portion. The client portion is implemented on one or more user devices (e.g., devices 150a, 150b, 150c) and may communicate with a computing server via one or more networks. The components and functions of DA 200 are implemented in hardware, software instructions for execution by one or more processors, firmware (e.g., one or more signal processing and/or application specific integrated circuits), or a combination or sub-combination thereof. It will be appreciated that DA 200 is exemplary, and thus DA 200 can have more or fewer components than shown, can combine two or more components, or can have a different configuration or arrangement of the components.

As described below, DA 200 performs at least some of: automatic speech recognition (e.g., using speech to text (STT) module 202); determining a user intent corresponding to received natural language input; determining a task flow to satisfy the determined intent; and executing the task flow to satisfy the determined intent.

In some examples, DA 200 includes natural language processing (NLP) module 204 configured to determine the user intent. NLP module 204 receives candidate text representation(s) generated by STT module 202 and maps each of the candidate text representations to a “user intent” recognized by the DA. A “user intent” corresponds to a DA performable task and has an associated task flow implemented in task module 206. The associated task flow includes a series of programmed actions (e.g., executable instructions) the DA takes to perform the task. The scope of DA 200's capabilities can thus depend on the types of task flows implemented in task module 206, e.g., depend on the types of user intents the DA recognizes.

In some examples, upon identifying a user intent based on the natural language input, NLP module 204 causes task module 206 to perform the actions for satisfying the user request. For example, task module 206 executes the task flow corresponding to the determined intent to perform a task satisfying the user request. In some examples, performing the task includes causing system 150 to provide graphical, audio, and/or haptic output indicating the performed task.

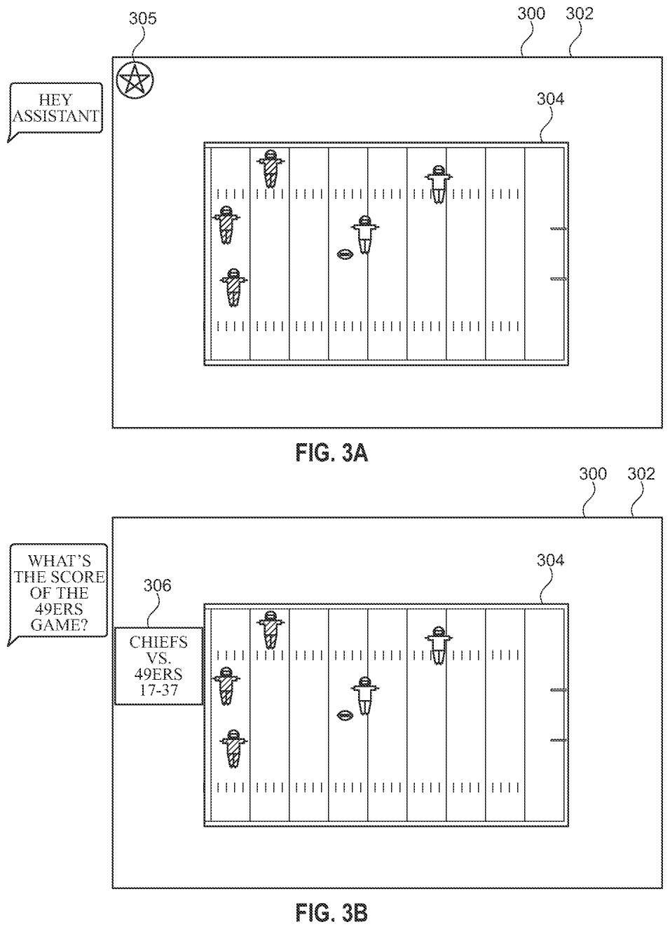

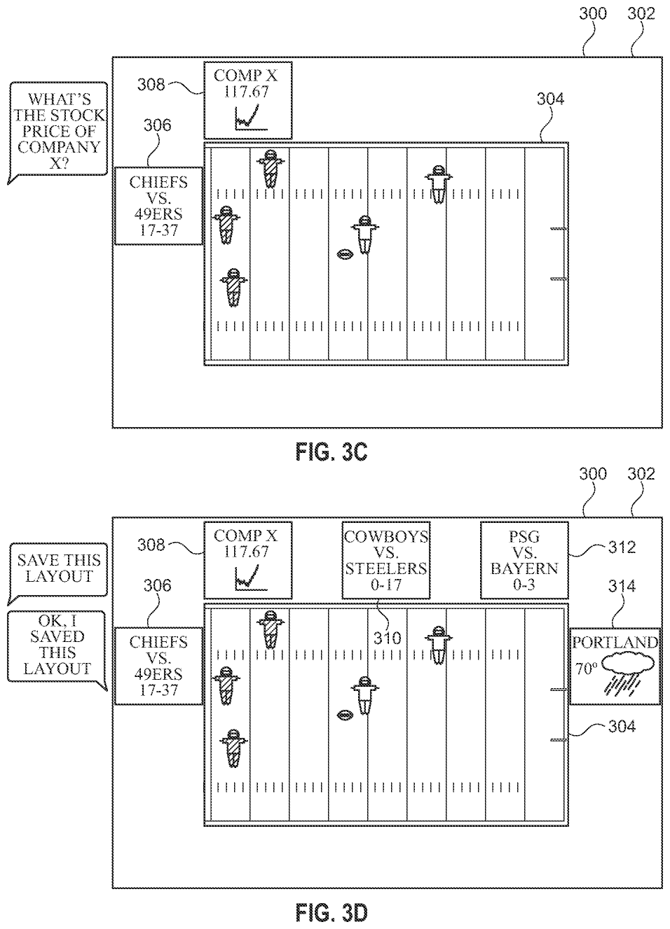

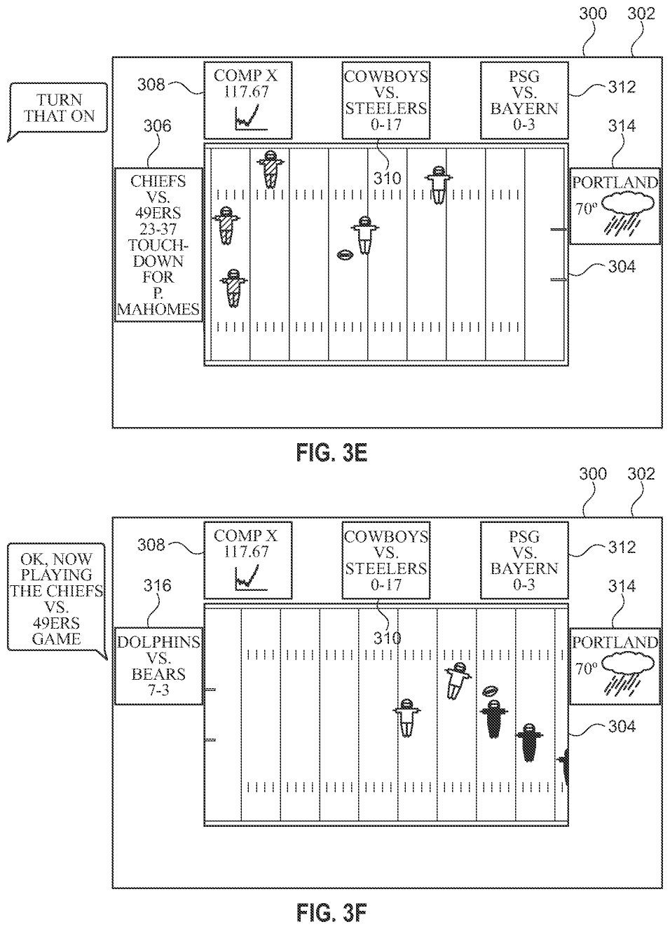

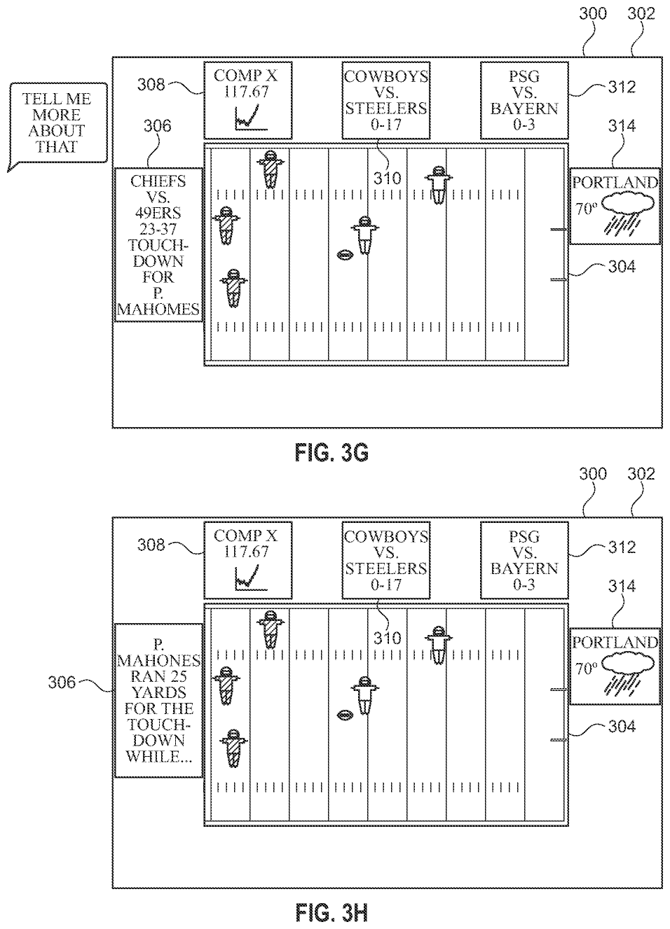

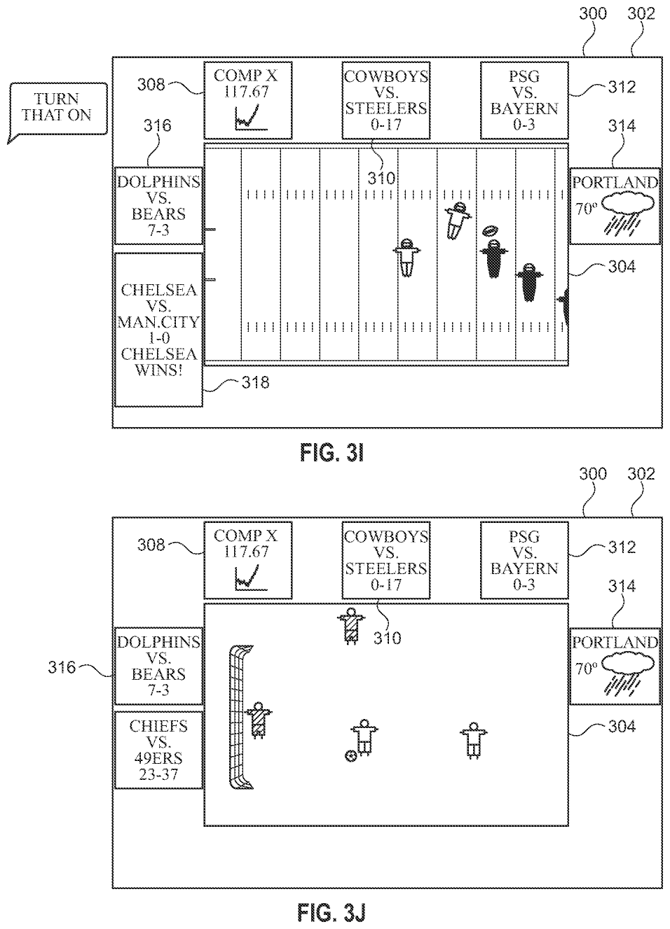

FIGS. 3A-3J illustrate various content displayed on display 302 of device 300, according to various examples. Device 300 is implemented, for example, as a head-mounted device, a smartphone device, a laptop computer, a desktop computer, a tablet device, a smart speaker, a television, or a smart home appliance. Device 300 is implemented as device 150a or device 150c.

In FIG. 3A, display 302 displays primary region 304 including a user interface. In some examples, primary region 304 is the main display area of device 300. For example, primary region 304 occupies a majority of display 302 and a user's attention may be largely directed to the user interface of primary region 304. In the present example, the user interface displays a sporting event, e.g., a live football game provided by a video enabled application of device 300. In other examples, the user interface corresponds to a home screen of device 300 or another application of device 300 (e.g., word processing application, messaging application, web browsing application, photos application, gaming application, and the like).

In some examples, primary region 304 displays the user interface via video pass-through depicting a display of an external electronic device (e.g., a laptop computer, a desktop computer, a tablet device, or a television). Accordingly, display 302 and the display of the external electronic device concurrently display the user interface, e.g., as a physical element. For example, the user may view the live football game on device 300 via video pass-through of the user's television displaying the live football game. In other examples, primary region 304 does not display the user interface via video-pass through. For example, device 300 may stream the live football game using an internet connection.

While the user views the live football game, the user may be interested in other events (e.g., sports games, competitions, stock price updates, weather updates, breaking news, system or application notifications, notifications from external devices (e.g., messages, phone calls), and the like). Accordingly, the below describes techniques for informing users about other events of interest and for allowing users to interact with (e.g., view) the other events.

In some examples, device 300 receives input to invoke DA 200. Example input to invoke DA 200 includes speech input including a predetermined spoken trigger (e.g., “hey assistant,” “turn on,” and the like), predetermined types of gesture input (e.g., hand motions) detected by device 300, and selection of a physical or virtual button of device 300. In some examples, input to invoke DA 200 includes user gaze input, e.g., indicating that user gaze is directed to a particular displayed user interface element for a predetermined duration. In some examples, device 300 determines that user gaze input is input to invoke DA 200 based on the timing of received natural language input relative to the user gaze input. For example, user gaze input invokes DA 200 if device 300 determines that user gaze is directed to the user interface element at a start time of the natural language input and/or at an end time of the natural language input. In the example of FIG. 3A, a user provides the spoken trigger “hey assistant” to invoke DA 200.

In FIG. 3A, DA 200 invokes. For example, device 300 displays DA indicator 305 to indicate invoked DA 200 and begins to execute certain processes corresponding to DA 200. In some examples, once DA 200 invokes, DA 200 processes received natural language input (e.g., speech input, text input) to perform various tasks, as described below. For simplicity, the description of some of FIGS. 3B-3J below does not explicitly describe receiving input to invoke DA 200. However, it will be appreciated that, in some examples, DA 200 processes the natural language inputs described with respect to FIGS. 3B-3J in accordance with receiving input to invoke DA 200.

Turning to FIG. 3B, device 300 receives a natural language input. For example, after being invoked, DA 200 receives the natural language input “what's the score of the 49ers game?”. DA 200 determines that the natural language input requests to display virtual affordance 306, e.g., a virtual user-interactive graphical element. For example, DA 200 determines, based on the natural language input, a user intent to display virtual affordance 306. DA 200 thus causes display 302 to display virtual affordance 306 concurrently with primary region 304.

Virtual affordance 306 has a first display state and display content. A display state of a virtual affordance describes the manner (e.g., size, shape, background color, movement, border style, font size, and the like) in which the virtual affordance is displayed. In contrast, the display content of a virtual affordance describes the information (e.g., sports scores, weather information, sports highlight information, stock information, news, and the like) the virtual affordance is intended to convey. For example, virtual affordances can have the same display state (e.g., same size, same border style) but different display content (e.g., indicate scores for different sports games). In the present example, the first display state of virtual affordance 306 does not emphasize virtual affordance 306. For example, virtual affordance 306 has the same first display state as other concurrently displayed virtual affordance(s), e.g., virtual affordance 308 discussed with respect to FIG. 3C below. In some examples, as discussed below, device 300 modifies the first display state of virtual affordance 306 to a second display state, e.g., to emphasize virtual affordance 306 relative to other concurrently displayed virtual affordance(s).

The display content of virtual affordance 306 represents an event and includes updates of the event. In some examples, the event is a live event (e.g., a live sports game, a live competition, live stock price information) and the display content of virtual affordance 306 includes live updates of the live event. For example, the display content represents a live Chiefs vs. 49ers football game and includes live updates of the football game (e.g., live score updates, live text describing the football game). In some examples, the display content includes video (e.g., live video) of the event, such as a live stream of the football game. In some examples, the user interface of primary region 304 corresponds to a second event different from the event. For example, the user interface displays a different live football game, e.g., a Dolphins vs. Bears football game.

In some examples, the user provides input to display virtual affordance 306 at a desired location. For example, responsive to the natural language input “what's the score of the 49ers game?”, DA 200 causes display 302 to display virtual affordance 306 at an initial location. The user then provides input (e.g., peripheral device input (e.g., mouse or touchpad input), gesture input (e.g., a drag and drop gesture), and/or speech input (e.g., “move this to the left”)) to move virtual affordance 306 to a desired location. For example, in FIG. 3B, display 302 initially displayed virtual affordance 306 to the right of primary region 304 and device 300 receives user input to display virtual affordance 306 to the left of primary region 304.

In FIG. 3C, in some examples, while displaying virtual affordance 306, device 300 receives a user input requesting to display virtual affordance 308. For example, the user provides the natural language input “what's the stock price of company X?” requesting DA 200 to display virtual affordance 308. In accordance with receiving the user input requesting to display virtual affordance 308, display 302 concurrently displays virtual affordance 306 and virtual affordance 308. In some examples, the user provides input to move virtual affordance 308 to the desired location in FIG. 3C.

The user can request device 300 to concurrently display any number of virtual affordances and move the virtual affordances to desired locations in a manner consistent with that discussed above. For example, FIG. 3D further shows virtual affordances 310, 312, and 314 requested by the user. Virtual affordances 306, 308, 310, 312, and 314 each have different display content (respectively representing live score updates of a Chiefs vs. 49ers football game, live updates of company X's stock price, live score updates of a Cowboys vs. Steelers football game, live score updates of a PSG vs. Bayern Munich soccer game, and live weather updates for Portland, Oregon) but each have the same first display state.

In some examples, the displayed virtual affordance(s) correspond to a virtual affordance layout indicating the respective display location(s) of the virtual affordance(s). For example, the virtual affordance layout in FIG. 3D specifies the virtual affordances 306-314 and their respective current display locations. In some examples, while the virtual affordance(s) are concurrently displayed according to the virtual affordance layout, device 300 receives a natural language input requesting to store the virtual affordance layout, e.g., “save this layout” in FIG. 3D. Other example natural language inputs requesting to store virtual affordance layouts include “remember this layout,” “store this arrangement,” “save my virtual affordances,” and the like. In accordance with receiving the natural language input, DA 200 stores the virtual affordance layout, e.g., by saving the currently displayed virtual affordance(s) and their respective display location(s). In some examples, DA 200 further provides output (e.g., audio output) indicating the stored virtual affordance layout, e.g., “ok, I saved this layout.”

In some examples, after storing the virtual affordance layout, device 300 receives a natural language input requesting to display the stored virtual affordance layout. Example natural language inputs requesting to display stored virtual affordance layouts include “show me my virtual affordances,” “show saved layout,” “display previous configuration,” and the like. In accordance with receiving the natural language input, DA 200 causes display 302 to concurrently display the virtual affordance(s) according to the stored virtual assistant layout. For example, in a future use of device 300, if display 302 displays primary region 304 without displaying virtual affordances 306-314, the user can cause display of virtual affordances 306-314 with the layout shown in FIG. 3D by requesting DA 200 to “show my saved layout.”

Turning to FIG. 3E, while concurrently displaying virtual affordance 306 and primary region 304 (and optionally other virtual affordance(s)), DA 200 detects a predetermined type of occurrence associated with the event represented by virtual affordance 306. In some examples, a predetermined type of occurrence represents a notable moment (e.g., highlight) associated with the event. In some examples, predetermined types of occurrences are defined based on the associated event. For example, for sports games and competitions, predetermined types of occurrences include goals, touchdowns, new records, upsets, fouls, a declared winner, and the like. As another example, for stock price updates, predetermined types of occurrences include large price changes and the stock price changing above or below a user specified price. As another example, for weather updates, a predetermined type of occurrence includes a severe weather warning. As another example, for notifications from external devices, a predetermined type of occurrence includes a notification (e.g., phone call, text message, email) from a user specified contact. In the example of FIG. 3E, the predetermined type of occurrence is that Patrick Mahomes of the Chiefs scored a touchdown in the Chiefs vs. 49ers football game.

In some examples, detecting the predetermined type of occurrence includes receiving an indication that the predetermined type of occurrence occurred in the event from an external electronic device. For example, DA 200 receives data from an external sports information service indicating that a predetermined type of occurrence occurred in a sports event of user interest (e.g., sports events represented by virtual affordances 306, 310, and 312). As another example, DA 200 receives notifications from a weather information service when a severe weather alert issues for a location of user interest (e.g., a location represented by virtual affordance 314). In some examples, DA 200 processes data associated with an event to detect associated predetermined types of occurrences. For example, DA 200 monitors the audio stream of each sports game represented by a displayed virtual affordance to detect predetermined types of occurrences. For example, DA 200 uses STT module 202 and/or NLP module 204 to detect words and/or phrases indicating the predetermined types of occurrences (e.g., “touchdown for the Chiefs” or “Chiefs win”). As another example, DA 200 monitors stock price data to determine when a stock price of user interest (e.g., represented by virtual affordance 308) changes above or below a user specified level.

In FIG. 3E, in response to detecting the predetermined type of occurrence, DA 200 causes display 302 to modify the first display state of virtual affordance 306 to a second display state different from the first display state. The second display state represents emphasis of virtual affordance 306, e.g., relative to other concurrently displayed virtual affordance(s). For example, virtual affordance 306, when displayed in the second display state in FIG. 3E, has a larger display size than when displayed in the first display state in FIG. 3D. In some examples, another display feature of virtual affordance 306 changes in the second display state relative to the first display state. For example, virtual affordance 306 includes a different background color, a different font size, a different border style, and/or moves (e.g., jiggles or vibrates) relative to virtual affordance 306 displayed in the first display state.

In some examples, in response to detecting the predetermined type of occurrence, device 300 provides output, such as audio output (e.g., “check this out”) and/or haptic output (e.g., a vibration).

In some examples, the display content of virtual affordance 306 changes when virtual affordance 306 is displayed in the second display state. For example, as shown, when virtual affordance 306 is displayed in the second display state, the display content includes a description (e.g., textual description) of the predetermined type of occurrence. For example, virtual affordance 306 includes the text “touchdown for P. Mahomes.” As another example, if a predetermined type of occurrence (e.g., large stock price change) occurs in the stock price represented by virtual affordance 308, display 302 displays virtual affordance 308 in the second display state and includes the text “company X's stock jumped by 20%” in virtual affordance 308. In some examples, virtual affordance 306 does not include video of the event when displayed in the first display state and includes video of the event when displayed in the second display state. For example, when Patrick Mahomes scores a touchdown, the display content of visual affordance 306 changes from indicating the score of the football game to displaying live video of the football game.

In some examples, virtual affordance 306 remains displayed in the second display state for a predetermined duration. After the predetermined duration elapses, display 302 reverts to displaying virtual affordance 306 in the first display state, e.g., like the display of virtual affordance 306 in FIG. 3D. In some examples, a user setting of device 300 specifies the predetermined duration.

In FIG. 3E, after modifying the first display state of virtual affordance 306 to the second display state, device 300 receives a speech input. In some examples, the speech input does not explicitly indicate virtual affordance 306 and includes a deictic reference (e.g., “that,” “this,” “the new one,” “the big one,” “the left one”) to virtual affordance 306. For example, the user speaks “turn that on” instead of “turn on the Chiefs vs. 49ers game.”

In some examples, DA 200 processes the speech input to perform a task without requiring input to invoke DA 200, e.g., input to invoke DA 200 otherwise received before, during, or after receiving the speech input. For example, DA 200 determines, based on various conditions associated with the speech input, that the speech input is intended for DA 200 and thus processes the speech input. An example condition includes that a detected user gesture corresponds to (e.g., the user points or gestures at) a displayed virtual affordance when receiving at least a portion of the speech input. In this manner, if the user speaks “turn that on” while pointing at virtual affordance 306, DA 200 processes the natural language input without requiring input to invoke DA 200.

Another example condition includes that a user intent determined based on the speech input corresponds to a virtual affordance (e.g., user intents requesting to display an event represented by a virtual affordance, to provide more detail about a virtual affordance, to cease to display a virtual affordance, to move a virtual affordance). Accordingly, if a determined user intent corresponds to a virtual affordance, DA 200 performs a task to satisfy the user intent without requiring input to invoke DA 200. If a determined user intent does not correspond to a virtual affordance, DA 200 ignores the speech input by not providing any output (e.g., unless DA 200 receives input to invoke). In some examples, DA 200 determines whether a user intent corresponds to a virtual affordance within a predetermined duration after initially displaying the virtual affordance in the second display state. Thus, within the predetermined duration, DA 200 performs a task, without requiring input to invoke DA 200, if the user intent corresponds to the virtual affordance. In some examples, after the predetermined duration elapses, DA 200 requires input to invoke DA 200 to process speech inputs to perform tasks.

In some examples, DA 200 automatically invokes (e.g., without requiring input to invoke DA 200) in response to virtual affordance 306 being displayed in the second display state. For example, when display 302 initially displays virtual affordance 306 in the second display state, DA 200 invokes (e.g., enters a listening mode) for a predetermined duration to detect speech inputs. If DA 200 does not detect speech input within the predetermined duration, DA 200 dismisses. For example, device 300 ceases to display DA indicator 305 and/or ceases to execute certain processes corresponding to DA 200. In some examples, during the predetermined duration, DA 200 processes a speech input to perform a task only if a user intent determined based on the speech input corresponds to a virtual affordance. Otherwise, DA 200 ignores the speech input, e.g., as discussed above.

In accordance with receiving the speech input, DA 200 determines whether the speech input corresponds to virtual affordance 306 based various context information discussed below. For example, DA 200 processes the speech input using STT module 202 and NLP module 204 to determine whether a user intent corresponds to a virtual affordance. If so, DA 200 determines the correct virtual affordance (e.g., virtual affordance 306) corresponding to the user intent using the context information. In this manner, DA 200 can determine a correct virtual affordance (and therefore a correct user intent) despite the speech input not explicitly indicating the correct virtual affordance. For example, as described below, DA 200 determines that “turn that on” means to display the Chiefs vs. 49ers football game represented by emphasized virtual affordance 306.

In some examples, DA 200 determines the context information based on the second display state of virtual affordance 306. For example, the determined context information indicates that virtual affordance 306 is displayed in the second display state while at least a portion of the speech input is received (or when DA 200 is invoked). In some examples, the determined context information indicates that virtual affordance 306 is displayed in the second display state a within a predetermined duration before the speech input is received (or before DA 200 invokes). In this manner, DA 200 determines that the speech input “turn that on” corresponds to virtual affordance 306 based on determining that display 302 displays virtual affordance 306 in the second display state while receiving the speech input, or that display 302 displayed virtual affordance 306 in the second display state shortly before receiving the speech input.

In some examples, the context information includes user gaze data (e.g., detected by image sensor(s) 105). For example, DA 200 determines that the speech input corresponds to virtual affordance 306 based on determining that user gaze is directed to virtual affordance 306 at a start time of the speech input or when DA 200 is invoked. In this manner, if a user gazes at virtual affordance 306 while speaking “turn that on,” DA 200 determines that the speech input corresponds to virtual affordance 306.

In some examples, the context information includes user gesture input (e.g., pointing gestures, touch gestures). For example, DA 200 determines that the speech input corresponds to virtual affordance 306 based on determining that a user gesture corresponds to virtual affordance 306 at a start time of the speech input or when DA 200 is invoked. In this manner, if a user gestures at (e.g., points at or touches the display of) virtual affordance 306 while speaking “turn that on,” DA 200 determines that the speech input corresponds to virtual affordance 306.

In some examples, determining that the speech input corresponds to virtual affordance 306 includes determining that the speech input refers to a position of a virtual affordance (e.g., using NLP module 204). For example, a user can provide speech inputs referring to virtual affordances based on their display locations, e.g., “turn on the bottom one,” “turn on the top middle one,” “turn on the right one”, and the like. In some examples, in accordance with a determination that the speech input refers to a position of a virtual affordance, DA 200 selects virtual affordance 306 based on the display location of virtual affordance 306. For example, in accordance with a determination that the speech input refers to a position of a virtual affordance, DA 200 analyzes the display layout of virtual affordance(s) to select the virtual affordance currently displayed at the referred-to location. In this manner, if the user speaks, “turn on the left one,” DA 200 determines that the speech input corresponds to virtual affordance 306.

In some examples, DA 200 further determines, based on the speech input, whether a user intent requests to display an event represented by virtual affordance 306 or requests another task associated with virtual affordance 306. Example other tasks include providing more detail about virtual affordance 306, ceasing to display virtual affordance 306, moving the display position of virtual affordance 306, and changing the display manner of (e.g., enlarging) virtual affordance 306. If DA 200 determines that the user intent requests another task associated with virtual affordance 306, DA 200 performs the other task.

Turning to FIG. 3F, in accordance with a determination that the speech input corresponds to virtual affordance 306 (and optionally in accordance with a determination that the user intent requests to display the event represented by virtual affordance 306), display 302 displays the event. For example, DA 200 causes display 302 to replace, in primary region 304, the display of the user interface with a display of the event. For example, in FIG. 3F, a live stream of the Chiefs vs. 49ers football game replaces the display of the previous Dolphins vs. Bears football game in primary region 304. In some examples, DA 200 further provides output (e.g., audio output) indicating the display of the event, e.g., “ok now playing the Chiefs vs. 49ers game.”

In some examples, displaying the event includes concurrently displaying, on display 302, the primary region displaying the event and virtual affordance 316 corresponding to the replaced user interface. Virtual affordance 316 is not displayed (e.g., in FIG. 3E) when the speech input is received. For example, in FIG. 3F, new virtual affordance 316 corresponds to the Dolphins vs. Bears football game previously displayed in primary region 304. In this manner, while the event displayed in primary region 304 may be of primary user interest (e.g., as a notable moment just occurred in the Chiefs vs. 49ers game), the user may still follow another event previously displayed in primary region 304. For example, the display content of virtual affordance 316 includes live score updates of the Dolphins vs. Bears football game.

In some examples, displaying the event includes ceasing to display virtual affordance 306. For example, in FIG. 3F, display 302 ceases to display virtual affordance 306, e.g., because primary region 304 now displays the event. In other examples, virtual affordance 306 remains displayed while display 302 displays the event in primary region 304.

While the above described techniques for displaying events are discussed with respect to virtual affordance 306, it will be appreciated that the techniques apply equally to any other displayed virtual affordance. For example, if a predetermined type of occurrence (e.g., a large stock price increase) associated with the stock price event represented by virtual affordance 308 occurs, display 302 displays virtual affordance 308 in a second display state. The user may then say “show me that.” DA 200 determines that the speech input “show me that” corresponds to virtual affordance 308 (e.g., as virtual affordance 308 was recently displayed in the second display state). DA 200 then causes display 302 to replace, in primary region 304, the display of the Dolphins vs. Bears football game with a display of the stock price event. For example, primary region 304 displays detailed information about company X's stock price, e.g., including an enlarged stock price chart, trading volume information, and moving average information.

Turning to FIGS. 3G-3H, in some examples, a user can select virtual affordance 306 without causing the event to replace the display of the user interface in primary region 304. For example after modifying the first display state of virtual affordance 306 to the second display state, device 300 receives a user input corresponding to a selection of virtual affordance 306. The user input includes, for example, speech input, gesture input (e.g., a pointing gesture, a tap gesture), or gaze input. In accordance with receiving the user input, display 302 modifies the display content of virtual affordance 306 without replacing, in primary region 304, the display of the user interface (e.g., Dolphins vs. Bears football game) with a display of the event (e.g., Chiefs vs. 49ers football game).

In some examples, the manner of modifying the display content of virtual affordance 306 depends on the user input. For example, for speech inputs, DA 200 modifies the display content according to a corresponding user intent. In FIG. 3G, for instance, while display 302 displays virtual affordance 306 in the second display state, device 300 receives a speech input, e.g., “tell me more about that.” DA 200 determines that the speech input corresponds to virtual affordance 306 and determines a user intent corresponding to the speech input. In the present example, the user intent requests to provide more detail about virtual affordance 306 (e.g., instead of requesting to display the event). Accordingly, DA 200 causes display 302 to modify the display content of virtual affordance 306 to include detailed information about the predetermined type of occurrence. For example, in FIG. 3F, responsive to “tell me more about that,” display 302 modifies the display content of virtual affordance 306 to include the description “Patrick Mahomes ran 25 yards for a touchdown while avoiding attempted tackles from Zack Kerr and Jordan Willis” that is more detailed than the previous description “touchdown for Patrick Mahomes.”

As another example, while display 302 displays virtual affordance 306 in the second display state, device 300 detects user gaze input corresponding to a selection of virtual affordance 306. For example, device 300 determines that the user gazes at virtual affordance 306 for a predetermined duration. In accordance with detecting the user gaze input, DA 200 causes display 302 to modify the display content of virtual affordance 306, e.g., to include detailed information about the predetermined type of occurrence, to include live video of the event, and/or to include a replay of the predetermined type of occurrence. As another example, while display 302 displays virtual affordance 306 in the second display state, device 300 detects user gesture input (e.g., a tap gesture, a pointing gesture) corresponding to a selection of virtual affordance 306. In accordance with detecting the user gesture input, DA 200 causes display 302 to modify the display content of virtual affordance 306, e.g., to include detailed information about the predetermined type of occurrence, to include live video of the event, and/or to include a replay of the predetermined type of occurrence.

Turning to FIG. 31, and continuing from the display of FIG. 3F, in some examples, display 302 proactively displays virtual affordance 318 corresponding to a predetermined event. For example, while virtual affordance 318 is not displayed (e.g., in FIG. 3F), DA 200 detects a predetermined type of occurrence associated with the predetermined event. The predetermined event and the associated predetermined type of occurrence are similar to that discussed above (e.g., a sports game and associated goals, touchdowns, declared winner). In response to detecting the predetermined type of occurrence, DA 200 causes display 302 to automatically display virtual affordance 318, e.g., without receiving user input to display virtual affordance 318 after detecting the predetermined type of occurrence.

In some examples, DA 200 determines the predetermined event, and detects predetermined types of occurrences associated with the predetermined event, based on user input. For example, a user previously instructed DA 200 to monitor the predetermined event for predetermined types of occurrences, e.g., by speaking “tell me who wins the Chelsea vs. Manchester City game” or “tell me when company Y's stock price falls below $100.” In some examples, DA 200 determines the predetermined event based on user preference or profile information stored on device 300. For example, based on user profile information indicating that the user is a Chelsea fan, DA 200 monitors all Chelsea soccer games for predetermined types of occurrences. In the example of FIG. 31, DA 200 detects that Chelsea has won a soccer game vs. Manchester City, and thus causes display 302 to display virtual affordance 318 having display content representing the soccer game.

In some examples, display 302 initially displays virtual affordance 318 in the second (e.g., emphasized) display state. For example, in FIG. 31 the display size of virtual affordance 318 is larger than the display sizes of virtual affordances 308-316 and the display content of virtual affordance 318 includes a description of the predetermined type of occurrence, e.g., “Chelsea wins!”. In other examples, display 302 displays virtual affordance 318 in the first (e.g., non-emphasized) display state, e.g., by displaying virtual affordance 318 with the same display sizes as virtual affordances 308-316.

FIG. 31 further shows that display 302 concurrently displays virtual affordance 318 and primary region 304 displaying the user interface (e.g., the Chiefs vs. 49ers game). In some examples, while concurrently displaying primary region 304 and virtual affordance 318, device 300 receives a speech input, e.g., “turn that on.” In some examples, device 300 further receives input to invoke DA 200 and DA 200 processes the speech input in accordance with invoking. In other examples, DA 200 processes the speech input to perform a task without receiving input to invoke DA 200, e.g., based on determining that the speech input is intended for DA 200 according to the techniques above. In some examples, DA 200 automatically invokes (e.g., for a predetermined duration) in response to the automatic display of virtual affordance 318. In some examples, as discussed above, during the predetermined duration, DA 200 only performs a task based on a detected speech input if a determined user intent corresponds to a virtual affordance.

DA 200 determines whether the speech input corresponds to virtual affordance 318. In some examples, DA 200 determines whether the speech input corresponds to virtual affordance 318 based on context information, consistent with the techniques discussed with respect to FIG. 3E (e.g., based on user gaze input, user gesture input, and/or that virtual affordance 318 is displayed in the second display state when receiving the speech input or when DA 200 is invoked). In some examples, determining that the speech input corresponds to virtual affordance 318 includes determining that device 300 receives the speech input within a predetermined duration after display 302 initially displays virtual affordance 318. For example, because display 302 recently and proactively displayed virtual affordance 318, the speech input “turn that on” likely corresponds to virtual affordance 318. In some examples, DA 200 further determines, based on the speech input, a user intent requesting to display the predetermined event represented by virtual affordance 318.

In some examples, in accordance with a determination that the speech input corresponds to virtual affordance 318 (and optionally in accordance with determining a user intent requesting to display the predetermined event), display 302 displays the predetermined event. For example, in FIG. 3J, DA 200 causes display 302 to replace, in primary region 304, the display of the user interface (e.g., the Chiefs vs. 49ers football game) with a display of the event (e.g., the Chelsea vs. Manchester City soccer game).

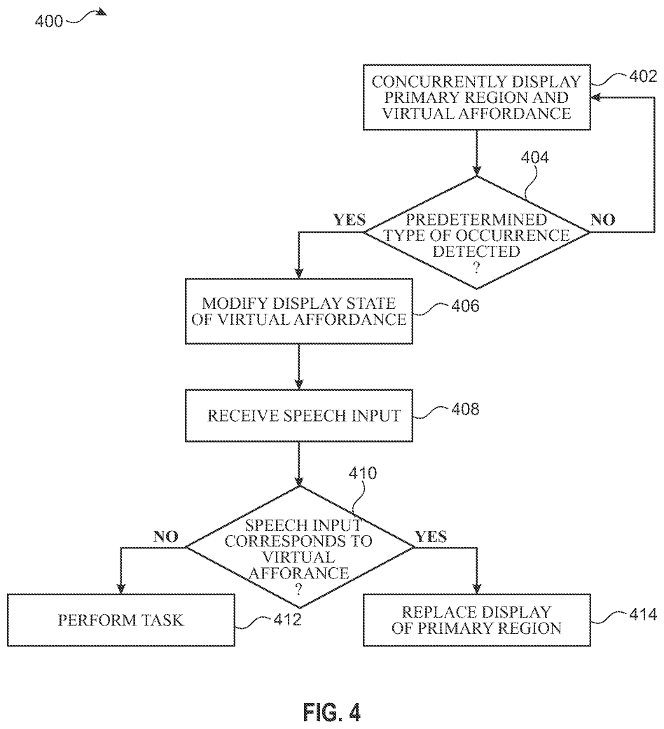

FIG. 4 illustrates process 400 for displaying an event, according to various examples. Process 400 is performed, for example, at a device (e.g., device 300) and using DA 200 and system 150. In process 400, some operations are, optionally, combined, the orders of some operations are, optionally, changed, and some operations are, optionally, omitted. In some examples, additional operations are performed in combination with process 400.

At block 402, a primary region (e.g., primary region 304) displaying a first user interface and a virtual affordance (e.g., virtual affordance 306) are concurrently displayed on a display (e.g., display 302). The virtual affordance has a first display state and display content, where the display content represents an event and includes updates of the event. In some examples, the event is a live event and the display content includes live updates of the live event. In some examples, the display content includes video of the event. In some examples, the first user interface corresponds to a second event different from the event. In some examples, the primary region displays the first user interface via video pass-through depicting a second display of an external electronic device and the display and the second display concurrently display the first user interface.

In some examples, prior to displaying the virtual affordance, a natural language input (e.g., “what's the score of the 49ers game?”) is received. In some examples, it is determined by a digital assistant operating on the electronic device (e.g., DA 200), that the natural language input requests to display the virtual affordance, where concurrently displaying the primary region and the virtual affordance is performed in accordance with a determination that the natural language input requests to display the virtual affordance.

In some examples, while displaying the virtual affordance, a user input requesting to display a second virtual affordance (e.g., virtual affordance 308) is received. In some examples, in accordance with receiving the user input requesting to display the second virtual affordance, the virtual affordance and the second virtual affordance are concurrently displayed on the display.

In some examples, the virtual affordance and the second virtual affordance correspond to a virtual affordance layout indicating the respective display locations of the virtual affordance and the second virtual affordance. In some examples, while the virtual affordance and the second virtual affordance are concurrently displayed according to the virtual affordance layout, a natural language input requesting to store the virtual affordance layout (e.g., “save this layout”) is received. In some examples, in accordance with receiving the natural language input requesting to store the virtual affordance layout, the virtual affordance layout is stored by the digital assistant.

In some examples, after storing the virtual affordance layout, a natural language input requesting to display the stored virtual affordance layout is received. In some examples, in accordance with receiving the natural language input, the virtual affordance and the second virtual affordance are concurrently displayed, on the display, according to the stored virtual affordance layout.

At block 404, while concurrently displaying the primary region and the virtual affordance it is determined whether a predetermined type of occurrence associated with the event is detected. In some examples, in accordance with a determination that the predetermined type of occurrence has not been detected, process 400 returns to block 402. In some examples, detecting the predetermined type of occurrence includes receiving, from a second external electronic device, an indication that the predetermined type of occurrence occurred in the event.

At block 406, in response to detecting the predetermined type of occurrence, the first display state of the virtual affordance is modified to a second display state different from the first display state (e.g., the second display state of virtual affordance 306 in FIG. 3E). In some examples, the virtual affordance, when displayed in the second display state, has a larger display size than when the virtual affordance is displayed in the first display state. In some examples, when the virtual affordance is displayed in the second display state, the display content includes a description of the predetermined type of occurrence. In some examples, when the virtual affordance is displayed in the first display state, the virtual affordance does not include video of the event and when the virtual affordance is displayed in the second display state, the virtual affordance includes video of the event.

At block 408, after modifying the first display state to the second display state, a speech input (e.g., “turn that on”) is received. In some examples, the speech input does not explicitly indicate the virtual affordance and the speech input includes a deictic reference to the virtual affordance.

At block 410, it is determined, using context information determined based on the second display state of the virtual affordance, whether the speech input corresponds to the virtual affordance. In some examples, the context information determined based on the second display state of the virtual affordance indicates that the virtual affordance is displayed in the second display state while the speech input is received or that the virtual affordance is displayed in the second display state within a predetermined duration before the speech input is received. In some examples, determining that the speech input corresponds to the virtual affordance includes detecting user gaze data and determining, based on the user gaze data, that the speech input corresponds to the virtual affordance. In some examples, determining that the speech input corresponds to the virtual affordance includes determining that the speech input refers to a position of the virtual affordance and in accordance with a determination that the speech input refers to a position of the virtual affordance, selecting the virtual affordance based on the display location of the virtual affordance.

In some examples, at block 412, in accordance with a determination that the speech input does not correspond to the virtual affordance, a task is performed based on the speech input. In some examples, performing the task includes providing output indicative of the task.

At block 414, in accordance with a determination that the speech input corresponds to the virtual affordance, the display of the first user interface in the primary region is replaced with a display of the event in the primary region. In some examples, replacing, in the primary region, the display of the first user interface with the display of the event includes concurrently displaying, on the display, the primary region displaying the event and a third virtual affordance (e.g., virtual affordance 316) corresponding to the first user interface, where the third virtual affordance is not displayed when the speech input is received. In some examples, replacing, in the primary region, the display of the first user interface with the display of the event includes ceasing to display the virtual affordance.

In some examples, after modifying the first display state to the second display state, second user input corresponding to a selection of the virtual affordance (e.g., “tell me more about that”) is received. In some examples, in accordance with receiving the second user input, the display content of the virtual affordance is modified without replacing, in the primary region, the display of the first user interface with the display of the event.

In some examples, while a fourth virtual affordance representing a predetermined event is not displayed, a second predetermined type of occurrence associated with the predetermined event is detected. In some examples, in response to detecting the second predetermined type of occurrence, the fourth virtual affordance (e.g., virtual affordance 318) is displayed on the display. In some examples, displaying the fourth virtual affordance includes concurrently displaying the primary region displaying the first user interface and the fourth virtual affordance. In some examples, while concurrently displaying the primary region displaying the first user interface and the fourth virtual affordance, a second speech input (e.g., “turn that on”) is received. In some examples, it is determined whether the second speech input corresponds to the fourth virtual affordance. In some examples, in accordance with a determination that the second speech input corresponds to the fourth virtual affordance, the display of the first user interface in the primary region is replaced with a display of the predetermined event in the primary region. In some examples, determining whether the second speech input corresponds to the fourth virtual affordance includes determining whether the second speech input is received within a second predetermined duration after the fourth virtual affordance is initially displayed.

The operations discussed above with respect to FIG. 4 are optionally implemented by the components depicted in FIG. 2, e.g., by system 150 and DA 200.

In some examples, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In some examples, an electronic device is provided that comprises means for performing any of the methods or processes described herein.

In some examples, an electronic device is provided that comprises a processing unit configured to perform any of the methods or processes described herein.

In some examples, an electronic device is provided that comprises one or more processors and memory storing one or more programs for execution by the one or more processors, the one or more programs including instructions for performing any of the methods or processes described herein.

Various techniques described in the present disclosure involve gathering and using personal information of a user. For example, the personal information (e.g., user gaze data) may be used to determine the correct event to display. However, when the personal information is gathered, the information should be gathered with the user's informed consent. In other words, users of the XR systems described herein should have knowledge of and control over how their personal information is used.

Only appropriate parties should use the personal information, and the appropriate parties should only use the personal information for reasonable and legitimate purposes. For example, the parties using the personal information will comply with privacy policies and practices that, at a minimum, obey appropriate laws and regulations. Further, such policies should be well-established, user-accessible, and recognized as in compliance with, or to exceed, governmental/industrial standards. Additionally, these parties will not distribute, sell, or otherwise share such information for unreasonable or illegitimate purposes.

Users may also limit the extent to which their personal information is accessible (or otherwise obtainable) by such parties. For example, the user can adjust XR system settings or preferences that control whether their personal information can be accessed by various entities. Additionally, while some examples described herein use personal information, various other examples within the scope of the present disclosure can be implemented without needing to use such information. For example, if personal information (e.g., gaze data) is gathered, the systems can obscure or otherwise generalize the information so the information does not identify the particular user.

What is claimed is:

1. A non-transitory computer-readable storage medium storing one or more programs, the one or more programs comprising instructions, which when executed by one or more processors of an electronic device having a display, cause the electronic device to:
concurrently display, on the display:
a primary region displaying a first user interface; and
a virtual affordance having a first display state and display content, wherein the display content represents an event and includes updates of the event;
while concurrently displaying the primary region and the virtual affordance:
detect a predetermined type of occurrence associated with the event;
in response to detecting the predetermined type of occurrence, modify the first display state of the virtual affordance to a second display state different from the first display state;
after modifying the first display state to the second display state, receive a speech input; and
determine, using context information determined based on the second display state of the virtual affordance, whether the speech input corresponds to the virtual affordance; and
in accordance with a determination that the speech input corresponds to the virtual affordance, replace, in the primary region, the display of the first user interface with a display of the event.

2. The non-transitory computer-readable storage medium of claim 1, wherein:
the event is a live event; and
the display content includes live updates of the live event.

3. The non-transitory computer-readable storage medium of claim 1, wherein the display content includes video of the event.

4. The non-transitory computer-readable storage medium of claim 1, wherein the first user interface corresponds to a second event different from the event.

5. The non-transitory computer-readable storage medium of claim 1, wherein:
the primary region displays the first user interface via video pass-through depicting a second display of an external electronic device; and
the display and the second display concurrently display the first user interface.

6. The non-transitory computer-readable storage medium of claim 1, wherein the virtual affordance, when displayed in the second display state, has a larger display size than when the virtual affordance is displayed in the first display state.

7. The non-transitory computer-readable storage medium of claim 1, wherein when the virtual affordance is displayed in the second display state, the display content includes a description of the predetermined type of occurrence.

8. The non-transitory computer-readable storage medium of claim 1, wherein:
when the virtual affordance is displayed in the first display state, the virtual affordance does not include video of the event; and
when the virtual affordance is displayed in the second display state, the virtual affordance includes video of the event.

9. The non-transitory computer-readable storage medium of claim 1, wherein detecting the predetermined type of occurrence includes receiving, from a second external electronic device, an indication that the predetermined type of occurrence occurred in the event.

10. The non-transitory computer-readable storage medium of claim 1, wherein the one or more programs further comprise instructions, which when executed by the one or more processors, cause the electronic device to:
prior to displaying the virtual affordance, receive a natural language input; and
determine, by a digital assistant operating on the electronic device, that the natural language input requests to display the virtual affordance, wherein concurrently displaying the primary region and the virtual affordance is performed in accordance with a determination that the natural language input requests to display the virtual affordance.

11. The non-transitory computer-readable storage medium of claim 10, wherein the one or more programs further comprise instructions, which when executed by the one or more processors, cause the electronic device to:
while displaying the virtual affordance, receive a user input requesting to display a second virtual affordance; and
in accordance with receiving the user input requesting to display the second virtual affordance, concurrently display, on the display, the virtual affordance and the second virtual affordance.

12. The non-transitory computer-readable storage medium of claim 11, wherein the virtual affordance and the second virtual affordance correspond to a virtual affordance layout indicating the respective display locations of the virtual affordance and the second virtual affordance, and wherein the one or more programs further comprise instructions, which when executed by the one or more processors, cause the electronic device to:
while the virtual affordance and the second virtual affordance are concurrently displayed according to the virtual affordance layout, receive a natural language input requesting to store the virtual affordance layout; and
in accordance with receiving the natural language input requesting to store the virtual affordance layout, store, by the digital assistant, the virtual affordance layout.

13. The non-transitory computer-readable storage medium of claim 12, wherein the one or more programs further comprise instructions, which when executed by the one or more processors, cause the electronic device to:
after storing the virtual affordance layout, receive a natural language input requesting to display the stored virtual affordance layout; and
in accordance with receiving the natural language input, concurrently display, on the display, the virtual affordance and the second virtual affordance according to the stored virtual affordance layout.

14. The non-transitory computer-readable storage medium of claim 1, wherein replacing, in the primary region, the display of the first user interface with the display of the event includes:
concurrently displaying, on the display, the primary region displaying the event and a third virtual affordance corresponding to the first user interface, wherein the third virtual affordance is not displayed when the speech input is received.

15. The non-transitory computer-readable storage medium of claim 1, wherein replacing, in the primary region, the display of the first user interface with the display of the event includes:
ceasing to display the virtual affordance.

16. The non-transitory computer-readable storage medium of claim 1, wherein the one or more programs further comprise instructions, which when executed by the one or more processors, cause the electronic device to:
after modifying the first display state to the second display state, receive a second user input corresponding to a selection of the virtual affordance; and
in accordance with receiving the second user input, modify the display content of the virtual affordance without replacing, in the primary region, the display of the first user interface with the display of the event.

17. The non-transitory computer-readable storage medium of claim 1, wherein the context information determined based on the second display state of the virtual affordance indicates that the virtual affordance is displayed in the second display state while the speech input is received or that the virtual affordance is displayed in the second display state within a predetermined duration before the speech input is received.

18. The non-transitory computer-readable storage medium of claim 1, wherein determining that the speech input corresponds to the virtual affordance includes:
detecting user gaze data, and
determining, based on the user gaze data, that the speech input corresponds to the virtual affordance.

19. The non-transitory computer-readable storage medium of claim 1, wherein determining that the speech input corresponds to the virtual affordance includes:
determining that the speech input refers to a position of the virtual affordance; and
in accordance with a determination that the speech input refers to a position of the virtual affordance, selecting the virtual affordance based on the display location of the virtual affordance.

20. The non-transitory computer-readable storage medium of claim 1, wherein the speech input does not explicitly indicate the virtual affordance and the speech input includes a deictic reference to the virtual affordance.

21. The non-transitory computer-readable storage medium of claim 1, wherein the one or more programs further comprise instructions, which when executed by the one or more processors, cause the electronic device to:
while a fourth virtual affordance representing a predetermined event is not displayed, detect a second predetermined type of occurrence associated with the predetermined event; and
in response to detecting the second predetermined type of occurrence, display, on the display, the fourth virtual affordance.

22. The non-transitory computer-readable storage medium of claim 21, wherein displaying the fourth virtual affordance includes concurrently displaying the primary region displaying the first user interface and the fourth virtual affordance, and wherein the one or more programs further comprise instructions, which when executed by the one or more processors, cause the electronic device to:
while concurrently displaying the primary region displaying the first user interface and the fourth virtual affordance, receive a second speech input;
determine whether the second speech input corresponds to the fourth virtual affordance; and
in accordance with a determination that the second speech input corresponds to the fourth virtual affordance, replace, in the primary region, the display of the first user interface with a display of the predetermined event.

23. The non-transitory computer-readable storage medium of claim 22, wherein determining whether the second speech input corresponds to the fourth virtual affordance includes determining whether the second speech input is received within a second predetermined duration after the fourth virtual affordance is initially displayed.

24. An electronic device comprising:
a display;
one or more processors;
a memory; and
one or more programs, wherein the one or more programs are stored in the memory and configured to be executed by the one or more processors, the one or more programs including instructions for:
concurrently displaying, on the display:
a primary region displaying a first user interface; and
a virtual affordance having a first display state and display content, wherein the display content represents an event and includes updates of the event;
while concurrently displaying the primary region and the virtual affordance:
detecting a predetermined type of occurrence associated with the event;
in response to detecting the predetermined type of occurrence, modifying the first display state of the virtual affordance to a second display state different from the first display state;
after modifying the first display state to the second display state, receiving a speech input; and
determining, using context information determined based on the second display state of the virtual affordance, whether the speech input corresponds to the virtual affordance; and
in accordance with a determination that the speech input corresponds to the virtual affordance, replacing, in the primary region, the display of the first user interface with a display of the event.

25. A method, comprising:
at an electronic device having one or more processors, memory, and a display:
concurrently displaying, on the display:
a primary region displaying a first user interface; and
a virtual affordance having a first display state and display content, wherein the display content represents an event and includes updates of the event;
while concurrently displaying the primary region and the virtual affordance:
detecting a predetermined type of occurrence associated with the event;
in response to detecting the predetermined type of occurrence, modifying the first display state of the virtual affordance to a second display state different from the first display state;
after modifying the first display state to the second display state, receiving a speech input; and
determining, using context information determined based on the second display state of the virtual affordance, whether the speech input corresponds to the virtual affordance; and
in accordance with a determination that the speech input corresponds to the virtual affordance, replacing, in the primary region, the display of the first user interface with a display of the event.
